(19) United States
(12) Patent Application Publication
(10) Pub. No.: US 2021/0129837 A1
(43) Pub. Date: May 6, 2021

(54) METHOD FOR COLLISION PREVENTION

(71) Applicant: Volkswagen Aktiengesellschaft, Wolfsburg (DE)

(72) Inventors: Daniel Gohlke, Wasbüttel (DE); Stefan Milch, Hemkenrode (DE)

(21) Appl. No.: 16/997,852

(22) Filed: Aug. 19, 2020

(30) Foreign Application Priority Data
Aug. 23, 2019 (DE) 102019212667.7

(51) Int. Cl. B60W 30/095; B60W 30/09; B60W 50/14

(52) U.S. Cl. CPC B60W 30/0956; B60W 30/09; B60W 2554/80; B60W 2554/4044; B60W 50/14

(57) ABSTRACT

Technologies and techniques utilizing collision prevention for a vehicle and an object. The object may be identified and a space may be generated for the object, Where the space occupied by a detected object may be expanded virtually and treated as part of the detected object.

### RELATED APPLICATIONS

The present application claims priority to German Patent App. No. DE 102019212667.7 to Daniel Gohlke et al., titled “Method for Collision Prevention,” filed Aug. 23, 2019, the contents of which being incorporated by reference in their entirety herein.

### BACKGROUND

The present disclosure relates to a method for collision prevention.

There is an increasing tendency toward automation in the vehicle industry, in particular the automotive industry.

There are currently driver assistance systems that can assume numerous different partially automated and fully automated driving functions. Fully autonomous vehicles are already being tested in which the driver assistance systems can assume all routine driving tasks.

In the field of emergency braking assistance, vehicles may predict future movement of the vehicle and to check whether this predicted trajectory will result in a collision with other objects.

The future locations of the other objects are also predicted on the basis of their current movement.

Until now, only the known ego extensions and, if known, object extension, are used for the prediction.

For driver assistance functions that pertain to road intersections, this modeling is no longer sufficient, because chances of a collision are higher in these areas.

A method for detecting collisions between two vehicles is known, for example, from DE 10 2011 109 697 A1, in which the length and width of an oncoming vehicle is determined, and the movements of the first vehicle and the oncoming vehicle are extrapolated.

DE 20 2013 008 112 U1 describes another method in which it is determined whether another vehicle is turning. If this is the case, it is then determined whether the first vehicle is still able to maintain a sufficient minimum distance to the turning vehicle.

A device for avoiding collisions between a turning vehicle and the oncoming traffic is known from DE 10 2017 205 737 A1. A collision probability is determined therewith, based on the movements of the two vehicles and an assumed slowing of the oncoming traffic.

A technological solution is therefore needed for collision prevention that increases safety.

### BRIEF SUMMARY

In some examples, technologies and techniques are disclosed for collision prevention for a vehicle, which may include the steps of detecting an object and determining a current movement of a detected object; predicting the movement of the detected object and the movement of the vehicle; checking the predicted movement paths for intersections; and executing a preventive reaction if an intersection has been detected.

### BRIEF DESCRIPTION OF THE DRAWINGS

Features of the present disclosure are explained below in reference to the associated drawings using exemplary embodiments. Therein:

FIG. 1 shows a vehicle according to the invention in a method according to the invention.

### DETAILED DESCRIPTION

In some examples, a safety region may be defined, at least in sections, around a detected object, which moves with the object in the prediction of the movement of the detected object, and which then triggers a preventive reaction if the predicted movement of the vehicle intersects with the predicted movement of the safety region.

In other words, the spatial region occupied by the detected object may be expanded virtually, and treated as part of the detected object. The virtual expansion of the spatial region may be adjusted to suit a particular application. A reasonable safety region may be determined on the basis of the technical teachings disclosed herein, taking into account the type of driver assistance system for executing the method and any safety-relevant driving situations.

The safety region can be located, for example, in front of the object in the direction the object is moving. The safety region may also surround the detected object entirely.

In some examples, parts of the safety region, between the areas of the safety region described above, may be emphasized.

In order to prevent inappropriate preventive reactions, the safety region may become smaller as the time in which the predicted movement of the detected object approaches. Starting at a specific time, this safety region can also be entirely omitted under some examples.

In some examples, by starting at a specific distance between the vehicle and the oncoming object, the chances of a collision may decrease until they are minimized. Furthermore, the precision of the prediction of the movement of the detected object decreases as the distance decreases, such that this definition of the safety region may no longer be statistically significant starting at a certain distance. As a result, the computing power necessary for simulating the safety region can also be reduced.

In some examples, the object detection may take place by determining an expansion of the detected object.

Sensors on the vehicle, such as cameras, radars or distance sensors, can precisely determine the geometry of the detected object. This enables a useful shaping of the safety region in relation to the actual geometry of the object. The precision of the measurement differs from one sensor to another. In some examples, cameras or lidar systems may be used, as they tend to be more precise than radar or ultrasound when detecting a shape.

In some examples, a safety region may be defined based on a characteristic of a current movement of the detected object.

The characteristic can comprise, for example, the speed, and changes thereto. As a result, it is possible to classify detected objects are having higher or lower risks, such that the safety region can be adapted accordingly thereto.

In some examples, the size of the defined safety region may increase as the current speed of the detected object increases.

In some examples, it may be assumed that a fast object is a greater risk, for example, at a road intersection or when turning through oncoming traffic, such that a larger safety region is provided. With slower objects, including stationary objects, the safety region can be smaller. With a stationary object, it can be reduced to a minimal safety region in some examples. This can also be enlarged in relation to a permanently stationary object, if there is a possibility that the stationary object will move. The specific configuration may be modified according to the needed application by one of ordinary skill in the art.

In some examples, the size of the defined safety region may change, based on dynamics of characteristics of the current movement of the detected object.

In other words, the size of the safety region may depend on how often, and quickly, a current movement changes. For example, in the case of a frequently accelerating object, which also frequently changes direction, a larger safety region can be provided to compensate for the existing unpredictability. This feature may be advantageous in applications utilizing an autonomous vehicle platform, in terms of ensuring the greatest safety.

With manually driven vehicles, for example, it is also possible to reduce the size of the safety region in order to avoid unnecessarily distracting the driver with irrelevant warnings. This may be the case, for example, if the movement of the object only briefly intersects numerous times with that of the vehicle. This can be taken into account if the current movement of the object can be determined precisely enough in the case of manually driven vehicles that the briefly acceptable intersections still allow for a sufficiently early preventive reaction.

A person skilled in the art may determine the extent to which the safety region is to be modified for a specific vehicle based on the dynamics of the detected object.

In some examples, a preventive reaction may include an element including, but not limited to, an optical warning signal, an acoustic warning signal, driving dynamics warning signal, deceleration, and emergency braking.

In one example, a driving dynamics warning signal may be braking pressure. The preventive reaction can be regarded as preventive reactions of increasing intensity in the specified order, and selected based on the driving situation.

In some aspects, the present disclosure relates to a driver assistance system configured to execute the techniques described herein.

In some examples, the driver assistance system may include intersection assistance or turning assistance.

In these areas, collision prevention is an important feature.

Another aspect of the invention relates to a vehicle that comprises the driver assistance system according to the present disclosure.

The vehicle may be a motor vehicle, such as an automobile or a truck.

The various examples described herein may be advantageously combined with one another unless otherwise specified.

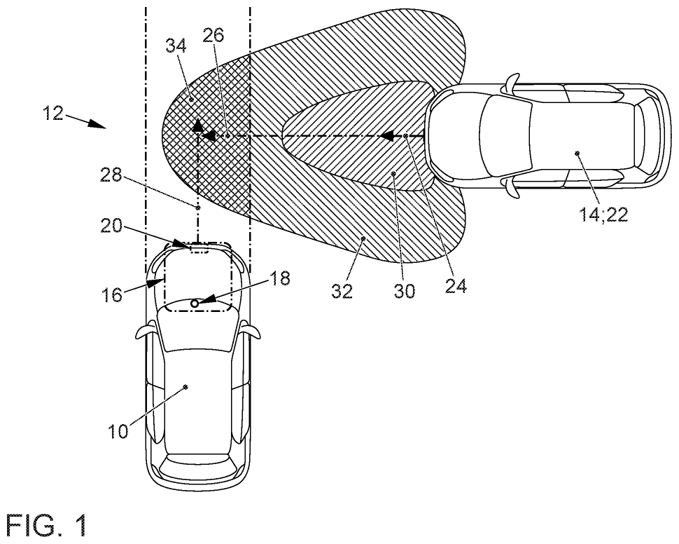

FIG. 1 shows a vehicle 10, located in an intersection 12, not shown in greater detail for the purpose of brevity.

The vehicle 10 is shown in the example moving from the bottom toward the top of FIG. 1. Another vehicle 14 is shown approaching the intersection 12 from the right side of the vehicle 10.

In one example, the vehicle 10 is equipped with a driver assistance system 16 according to the present disclosure, which may execute a plurality of processes.

The driver assistance system 16 may first detect an object, e.g., using a camera 18 and a radar sensor 20. The driver assistance system 16 may determine that the other vehicle 14 is a detected object 22. In the course of the object detection, the detected object 22 is also expanded.

The driver assistance system 16 may subsequently determine the current movement 24 of the detected object 22. The driver assistance system 16 also predicts the movement 26 of the detected object 22 and its own movement 28, or that of the vehicle 10.

Based on this, it is checked whether the predicted movement 26 and the predicted movement 28 of the vehicle intersect.

A safety region 30 is defined for this, which is in front of the approaching vehicle 14 in this example, and based on the acknowledged expansion, also partially encompasses the other vehicle 14.

The safety region 30 may be configured as part of the detected object 22 in the prediction of the movement 26 of the detected object 22, or other vehicle 14. Accordingly, the safety region 30 moves, virtually, with the other vehicle 14 in the movement prediction.

When checking for intersections 24 of the predicted movement 26 of the other vehicle and the predicted movement 28 of the first vehicle, an intersection 34 of the predicted movement 28 of the first vehicle 10 with the predicted movement 26 of the safety region 30 is taken into account.

If there is such an intersection 34, a preventive reaction is triggered.

In the illustrated example, no intersection 34 with the safety region 30 has been detected. Consequently, no preventive reaction is triggered. This may be the case, for example, because the vehicle 10 is moving fast enough to pass through the intersection 12, without intersecting with the safety region 30.

In some examples, a safety region 32 may be configured that differs from the first safety region 30.

It can be seen in the example that the safety region 32 is significantly larger than the first safety region 30. This is because the safety regions 30, 32 are defined based on a characteristic of the current movement 24 of the detected object 22.

The safety region 32 may be configured to be based on a current movement 24, by way of example, which is significantly faster than the current movement 24 for the first safety region 30.

For this reason, there is an intersection with the second safety region 32, resulting in the triggering of a preventive reaction.

The driver assistance system 16 may include intersection assistance, for example, which may result in a speed reduction on the part of the first vehicle 10 as a preventive reaction.

### LIST OF REFERENCE SYMBOLS

10 vehicle

12 road intersection

14 other vehicle

16 driver assistance system

18 camera

20 radar sensor

22 detected object

24 current movement

26 predicted movement

28 predicted movement of the first vehicle

30 safety region

32 safety region

34 intersection

1-9. (canceled)

10. A method of collision prevention for a vehicle, comprising:
detecting an object via one or more sensors
determining a current movement of the detected object;
predicting the movement of the detected object and the movement of the vehicle;
determining that the predicted movement paths of the detected object and the vehicle intersect; and
executing a preventive reaction for the vehicle.

11. The method of claim 10, wherein determining the object comprises determining an expansion of the detected object.

12. The method of claim 11, further comprising defining a safety region, based on a characteristic of the current movement of the detected object.

13. The method of claim 12, wherein a size of the defined safety region increases as a speed associated with the current movement of the detected object increases.

14. The method of claim 12, wherein a size of the defined safety region changes based on dynamics of characteristics of the current movement of the detected object.

15. The method of claim 10, wherein the executing of the preventive reaction comprises executing one of an optical warning signal, an acoustic warning signal, a driving dynamics warning signal, a vehicle deceleration action or a vehicle emergency braking action.

16. A collision prevention system for a vehicle, comprising:
one or more sensors; and
a driver assistance system, wherein the driver assistance system and one or more sensors are configured to
detect an object via one or more sensors
determine a current movement of the detected object;
predict the movement of the detected object and the movement of the vehicle;
determine the predicted movement paths of the detected object and the vehicle relative to one or more intersections; and
execute a preventive reaction for the vehicle if the predicted movement paths are determined to enter the one or more intersections.

17. The collision prevention system of claim 16, wherein the driver assistance system and one or more sensors are configured to determine the object by determining an expansion of the detected object.

18. The collision prevention system of claim 17, wherein the driver assistance system and one or more sensors are configured to define a safety region, based on a characteristic of the current movement of the detected object.

19. The collision prevention system of claim 18, wherein a size of the defined safety region increases as a speed associated with the current movement of the detected object increases.

20. The collision prevention system of claim 18, wherein a size of the defined safety region changes based on dynamics of characteristics of the current movement of the detected object.

21. The collision prevention system of claim 16, wherein the driver assistance system and one or more sensors are configured to execute the preventive reaction by executing one of an optical warning signal, an acoustic warning signal, a driving dynamics warning signal, a vehicle deceleration action or a vehicle emergency braking action.

22. The collision prevention system of claim 16, wherein the driver assistance system comprises intersection assistance or turning assistance.

23. A method of collision prevention for a vehicle, comprising:
detecting an object geometry via one or more sensors;
determining an expansion of the detected object geometry;
determining a current movement of the detected object;
predicting the movement of the detected object and the movement of the vehicle;
determining that the predicted movement paths of the detected object and the vehicle intersect; and
executing a preventive reaction for the vehicle.

24. The method of claim 23, further comprising defining a safety region, based on a characteristic of the current movement of the detected object.

26. The method of claim 24, wherein a size of the defined safety region increases as a speed associated with the current movement of the detected object increases.

27. The method of claim 24, wherein a size of the defined safety region changes based on dynamics of characteristics of the current movement of the detected object.

28. The method of claim 23, wherein the executing of the preventive reaction comprises executing one of an optical warning signal, an acoustic warning signal, a driving dynamics warning signal, a vehicle deceleration action or a vehicle emergency braking action.
